(19) United States
(12) Patent Application Publication
(10) Pub. No.: US 2025/0139520 A1
(43) Pub. Date: May 1, 2025

(54) NON-FUNGIBLE TOKEN PREDICTION USING SUPERVISED MACHINE LEARNING

(71) Applicant: Appraisal Bureau LLC, Atlanta, GA (US)

(72) Inventors: Caroline Davis Taylor, Atlanta, GA (US); Matthew Christopher Garland, Atlanta, GA (US)

(21) Appl. No.: 18/917,710

(22) Filed: Oct. 16, 2024

Related U.S. Application Data
(60) Provisional application No. 63/594,323, filed on Oct. 30, 2023.

(51) Int. Cl. G06N 20/00; G06F 16/2457

(52) U.S. Cl. CPC G06N 20/00; G06F 16/24578

(57) ABSTRACT

An application receives a request from a client device for information relating to a non-fungible token. The application determines, based on the request, a set of signals to extract relative to the non-fungible token. The application inputs the set of signals into a supervised machine learning model, and receives, as output from the supervised machine learning mode, a prediction for the non-fungible token. The application outputs, for display on the client device, the information relating to the non-fungible token, the information determined based on the prediction.

### CROSS REFERENCE TO RELATED APPLICATIONS

This application claims the benefit of U.S. Provisional Application No. 63/594,323, filed Oct. 30, 2023, which is incorporated by reference in its entirety.

### TECHNICAL FIELD

The disclosure generally relates to the field of machine learning, and more specifically relates to using a machine learning engine to determine an up-to-date and accurate prediction for a non-fungible token.

### BACKGROUND

Given that non-fungible tokens (NFTs) are by definition unique from one another, subjective prediction for NFTs has historically been a manual process. For example, appraisal of qualities of NFTs may include a human looking at not just the quality of its contents, but also who the author is, what their prior works are, and so on. This yields extreme volatility in appraisals from one appraiser to another, resulting in unreliable results.

Moreover, supervised machine learning approaches use training examples having attributes as labeled by a classification or value associated with the attributes. Where training examples are few in number, supervised machine learning approaches may yield inaccurate predictions when tasked with outputting a prediction of a classification or value for a new example. Classical approaches are therefore inaccurate for NFTs are therefore insufficient because few or no examples may exist for a given NFT, as the NFTs are unique in nature and may be transferred or associated with new values infrequently or not at all.

### SUMMARY

Systems and methods are disclosed herein that use a machine learning approach to forming predictions of values for NFTs, while addressing the technical problem of sparsity of training examples. In some embodiments, different machine learning models are used to form predictions for different collections of NFTs that share similar attributes, thereby enabling collection of a sufficient number of training examples to train a model to form predictions for those collections. Different approaches may be applied where an NFT for which a prediction is to be formed is not part of a collection.

In some embodiments, an application receives a request from a client device for information relating to a non-fungible token. The application determines, based on the request, a set of signals to extract relative to the non-fungible token. The application inputs the set of signals into a supervised machine learning model and receives, as output from the supervised machine learning mode, a prediction for the non-fungible token. The application outputs, for display on the client device, the information relating to the non-fungible token, the information determined based on the prediction.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1 illustrates one embodiment of a system environment for implementing an NFT appraisal service.

FIG. 2 illustrates one embodiment of modules of the NFT appraisal service.

FIG. 3 is a block diagram illustrating components of an example machine able to read instructions from a machine-readable medium and execute them in a processor (or controller).

FIG. 4 is a flowchart illustrating a process for generating a prediction for an NFT using a machine-learning approach.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

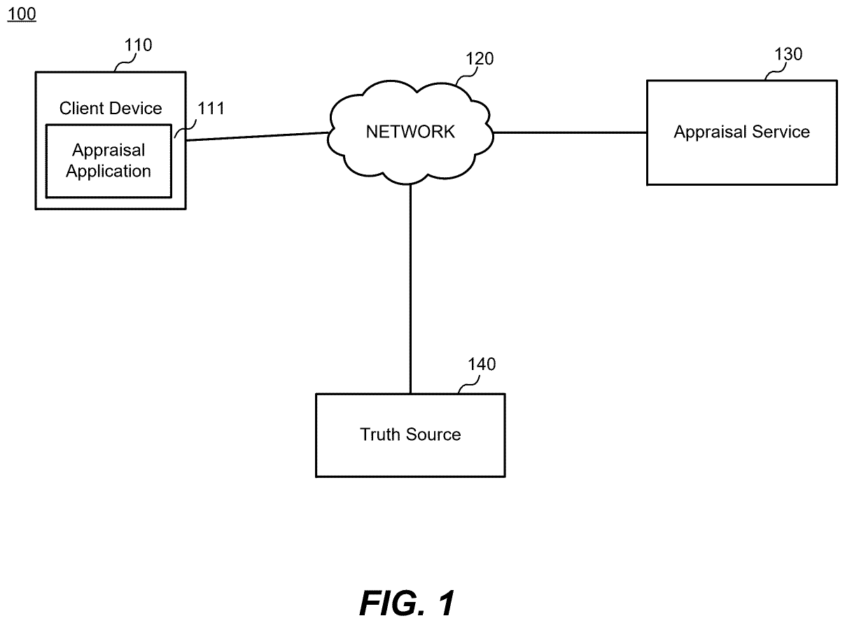

FIG. 1 illustrates one embodiment of a system environment for implementing an NFT appraisal service. As depicted in FIG. 1, appraisal service environment 100 includes various client devices, including client device 110, network 120, appraisal service 130, and truth source 140. A service, as used herein, is a collection of one or more cloud resources that together, perhaps in coordination with other activities, form a client-facing tool.

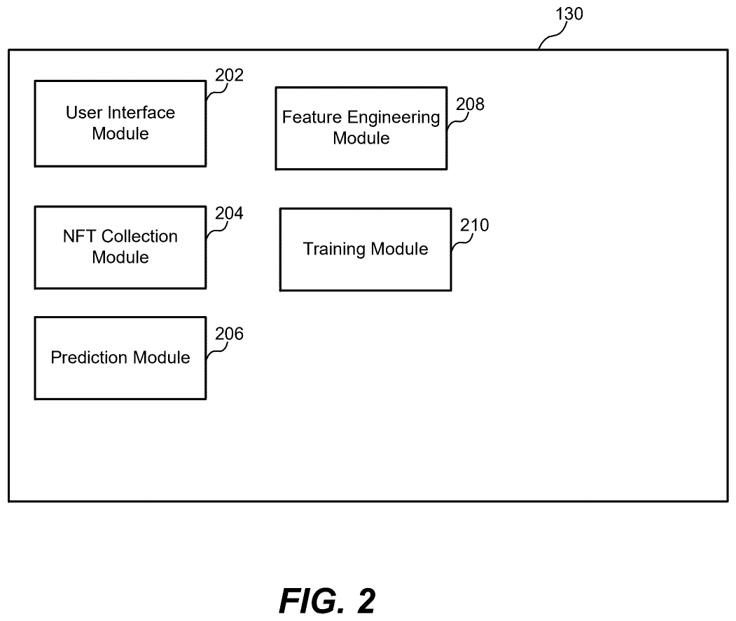

Appraisal service 130 is used by client devices 110 to provide appraisals of one or more characteristics of NFTs. NFTs, while often referring to tokenized digital art, may refer to any tokenized asset, whether digital or physical (e.g., cars, fashion, real estate, etc.). Client device 110 may, by way of appraisal application 111, interface with appraisal service 130. Appraisal application 111 is an application installed on client device 110 and/or accessible by way of a browser of client device 110. Some or all functionality of appraisal service 130 described herein may be distributed or fully performed by appraisal application 111 on a client device, or vice versa. Where reference is made herein to activity performed by appraisal application 111, it equally applies that appraisal service 130 may perform that activity off of the client device, and vice versa. Further details about the operation of appraisal service 130 are described below with reference to FIG. 2.

Truth source 140 may store historical data relating to NFTs and/or NFT collections (e.g., to source training data for machine learning models). Truth source 140 is depicted as one data collection, but may be formed by any number of data collections. Truth source 140 is depicted as not being part of appraisal service 130, but may in whole or in part be part of appraisal service 130.

FIG. 2 illustrates one embodiment of modules of the NFT appraisal service. As depicted in FIG. 2, appraisal service 130 includes user interface module 202, NFT collection module 204, prediction module 206, and feature engineering module 208. These modules and databases are merely illustrative; fewer or more modules and/or databases may be used to achieve the functionality disclosed herein.

User interface module 202 receives an appraisal request from a user of a client device. The appraisal request may include user input of one or more of a collection name, a collection address, and a token identifier (ID) for a particular NFT. The appraisal request may also include an input of a time (e.g., present time or seeking appraisal at a past time), or user interface module may determine a time associated with the request (e.g., a time at which the request was submitted, or an abstraction thereof, such as a date of the request). User interface module 202 may pass the information to other modules of appraisal service 130, and may receive information about the NFT. User interface module 202 may output the information to the user (e.g., using application 111 of the client device of the user).

NFT collection module 204 determines a collection to which the non-fungible token belongs. The collection may be expressly indicated by the user in making the appraisal request. Where the collection is not indicated, NFT collection module 204 may determine the collection based on other information within the appraisal request. For example, NFT collection module 204 may query a database that maps Token IDs to Collection IDs, and may receive in response to the query a corresponding Collection ID where the Collection ID is known, or a return of “unknown.” Where the Collection ID is known, NFT collection module 204 may determine the collection to be one that matches the Collection ID. Where the collection is unknown (or there is no collection because the NFT is one of one), NFT collection module 204 may determine that there is no corresponding collection.

In some embodiments, in order to determine a collection to which the non-fungible token belongs, NFT collection module 204 may generate an embedding vector with any number of characteristics of the non-fungible token, such as data input by the user regarding the non-fungible token, as well as any other derivable characteristics from the non-fungible token (e.g., descriptors of visible attributes of a physical or virtual object associated with the non-fungible token, metadata describing the non-fungible token, etc.). NFT collection module 204 may input the embedding vector into an unsupervised machine learning model, and may receive, as output from the unsupervised machine learning model, a coordinate in N-dimensional space. NFT collection module 204 may determine a cluster corresponding to the coordinate (e.g., using a nearest-neighbor search), and may determine the collection to which the non-fungible token belongs to be a collection corresponding to that cluster. NFT collection module 204 may determine that no cluster is sufficiently close to the coordinate, and may determine responsively determine that the non-fungible token is not part of a known collection.

Where a collection is known, prediction module 206 uses historical data from that collection to perform predictions and/or regression tasks with respect to the NFT. Prediction module 206 may access a supervised machine learning model to perform the prediction. In an embodiment, different machine learning models (e.g., classification, regression, etc.) are trained to output predictions for different NFT collections. In such an embodiment, prediction module 206 may select a machine learning model to perform the prediction by identifying a machine learning model that maps to the collection at issue. In order to train the different machine learning models that perform to different collections, training examples are obtained for each collection, each training example having a collection of attributes as labeled by a value for whatever characteristic is to be predicted (e.g., a value). Prediction module 206 may reference a data structure (e.g., a mapping table) that maps collections to their associated machine learning model when determining which machine learning model to select based on which collection a given non-fungible token corresponds to.

Prediction module 206 may determine a set of signals to extract relative to the NFT, input the set of signals into the selected model, and receive, as output from the supervised machine learning model, a prediction for the non-fungible token. Feature engineering module 208 may be used to determine which signals to extract from the NFT. Signals may include any attributes associated with the NFT. A collection of which the NFT is a part is one embodiment of such attributes, whether the NFT has particular traits might be another embodiment of such attributes, and a rate (or classification of rate) at which the NFT is transferred might be another. To perform this task, feature engineering module 208 may determine a contribution of each candidate feature to classification results of the supervised machine learning model (sometimes referred to as a “contribution analysis” herein). That is, for each output of the supervised machine learning model, feature engineering module 208 may determine a correlation between feature and outcome. Feature engineering module 208 may rank candidate features based on their contribution, and may determine the set of signals to correspond to ones of the candidate features having at least a threshold ranking. In this manner, feature engineering module 208 improves computational efficiency of the selected machine learning model, given that the machine learning model operates on fewer dimensions to produce a prediction than it otherwise would to process a superset of features including those that contribute insignificantly to classification.

Training module 210 trains machine learning models based on historical data as labeled by prediction/regression. For example, databases may store data for prior appraisals of NFT predictions, where underlying data (e.g., NFT name, date of appraisal, etc.) is stored as a training example and labeled by one or more subjective classifications of the NFT. Training module 210 may re-train the machine learning models periodically (e.g., daily, weekly, etc.) and/or in response to a trigger (e.g., an appraisal that deviates by at least X amount from an expected appraisal has occurred) in order to ensure that predictions are current. Moreover, training module 210 may retire older training data during retraining (e.g., a sliding window may be applied to the training examples, where as time passes, training examples that are beyond that time window are not used or are discounted in retraining).

In some embodiments, where no known collection matches a given non-fungible token, training module 210 may train a custom machine learning model for that given non-fungible token. Training module 210 may perform a nearest neighbor search of an embedding representative of the given non-fungible token using an unsupervised machine learning model (e.g., K-Means clustering or any other clustering model), where the nearest neighbor search may yield one or more collections within a threshold distance from the embedding. Where multiple collections are within the threshold distance, training data from those collections may be gathered and used to train the custom machine learning model for predicting the value for the given non-fungible token. The training data may be weighted based on distance, where nearer neighbors' training data is weighted more highly than further neighbors' training data.

The supervised machine learning models may include any form of model, such as gradient boosting, random forest, or any other model. In some embodiments, prediction module 206 may run multiple machine learning models. For example, a plurality of machine learning models may be trained for each collection (e.g., a gradient boosting model and a random forest model). For a given collection, two or more of the plurality of machine learning models may be run, and the output may be selected that has the highest R\hat{ }2 value.

Following training, feature engineering module 208 may monitor performance of the models relative to drift. Drift occurs when appraisal predictions differ by at least a threshold amount in a short (e.g., below a threshold amount of time) timeframe. Responsive to detecting drift, feature engineering module 208 may refresh its determination of features to extract as signals for input to the supervised machine learning model(s) by performing the contribution analysis anew based on the model as it has been retrained, and may determine the top contributing features as those that should act as the input signals.

### Computing Machine Architecture

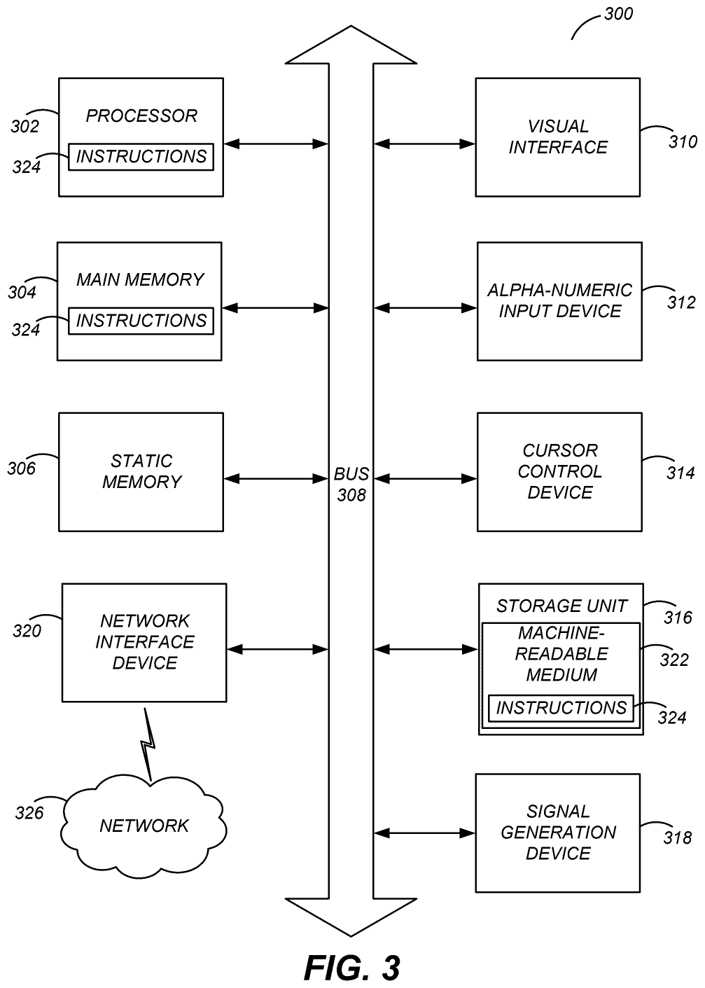

FIG. (FIG. 3 is a block diagram illustrating components of an example machine able to read instructions from a machine-readable medium and execute them in a processor (or controller). Specifically, FIG. 3 shows a diagrammatic representation of a machine in the example form of a computer system 300 within which program code (e.g., software) for causing the machine to perform any one or more of the methodologies discussed herein may be executed. The program code may be comprised of instructions 324 executable by one or more processors 302. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 324 (sequential or otherwise) that specify actions to be taken by that machine. Further, while only a single machine is illustrated, the term “machine” shall also be taken to include any collection of machines that individually or jointly execute instructions 124 to perform any one or more of the methodologies discussed herein.

The example computer system 300 includes a processor 302 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 304, and a static memory 306, which are configured to communicate with each other via a bus 308. The computer system 300 may further include visual display interface 310. The visual interface may include a software driver that enables displaying user interfaces on a screen (or display). The visual interface may display user interfaces directly (e.g., on the screen) or indirectly on a surface, window, or the like (e.g., via a visual projection unit). For ease of discussion the visual interface may be described as a screen. The visual interface 310 may include or may interface with a touch enabled screen. The computer system 300 may also include alphanumeric input device 312 (e.g., a keyboard or touch screen keyboard), a cursor control device 314 (e.g., a mouse, a trackball, a joystick, a motion sensor, or other pointing instrument), a storage unit 316, a signal generation device 318 (e.g., a speaker), and a network interface device 320, which also are configured to communicate via the bus 308.

The storage unit 316 includes a machine-readable medium 322 on which is stored instructions 324 (e.g., software) embodying any one or more of the methodologies or functions described herein. The instructions 324 (e.g., software) may also reside, completely or at least partially, within the main memory 304 or within the processor 302 (e.g., within a processor's cache memory) during execution thereof by the computer system 300, the main memory 304 and the processor 302 also constituting machine-readable media. The instructions 324 (e.g., software) may be transmitted or received over a network 326 via the network interface device 320.

While machine-readable medium 322 is shown in an example embodiment to be a single medium, the term “machine-readable medium” should be taken to include a single medium or multiple media (e.g., a centralized or distributed database, or associated caches and servers) able to store instructions (e.g., instructions 324). The term “machine-readable medium” shall also be taken to include any medium that is capable of storing instructions (e.g., instructions 324) for execution by the machine and that cause the machine to perform any one or more of the methodologies disclosed herein. The term “machine-readable medium” includes, but not be limited to, data repositories in the form of solid-state memories, optical media, and magnetic media.

### Exemplary Process for Generating NFT Prediction

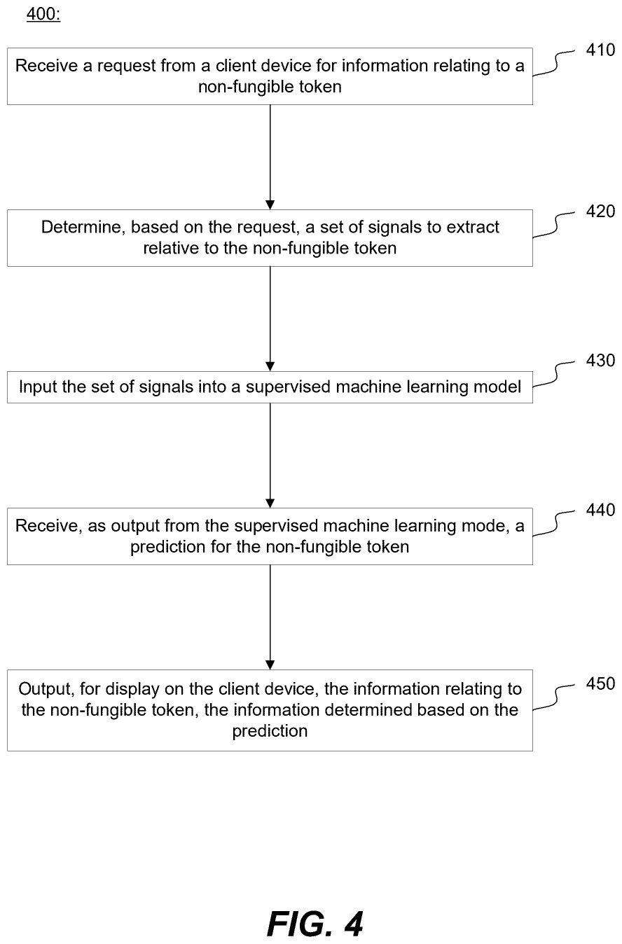

FIG. 4 is a flowchart illustrating a process for generating a prediction for an NFT using a machine-learning approach. Process 400 may be executed by one or more processors executing instructions that cause operations of the modules of appraisal service 130 to be performed. Process 400 may begin with appraisal service 130 receiving 410 a request from a client device for information relating to a non-fungible token (e.g., using user interface module 202). Appraisal service 130 may then determine 420, based on the request, a set of signals to extract relative to the non-fungible token (e.g., using NFT collection module 204).

Appraisal service 130 may input 430 the set of signals into a supervised machine learning model, and may receive 440, as output from the supervised machine learning mode, a prediction for the non-fungible token (e.g., using prediction module 206). Appraisal service 130 may output 450, for display on the client device (e.g., client device 11), the information relating to the non-fungible token, the information determined based on the prediction (e.g., using user interface module 202).

### Additional Configuration Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for determining an appraisal classification for an NFT through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method comprising:
receiving a request from a client device for information relating to a non-fungible token;
determining, based on the request, a set of signals to extract relative to the non-fungible token;
inputting the set of signals into a supervised machine learning model;
receiving, as output from the supervised machine learning mode, a prediction for the non-fungible token; and
outputting, for display on the client device, the information relating to the non-fungible token, the information determined based on the prediction.

2. The method of claim 1, further comprising selecting the supervised machine learning model from a plurality of candidate supervised machine learning model, each candidate supervised machine learning model corresponding to a different set of signals.

3. The method of claim 1, wherein determining the set of signals comprises:
determining, for the supervised machine learning model, a contribution of each candidate feature to prediction results of the supervised machine learning model;
ranking candidate features based on their contribution; and
determining the set of signals to correspond to ones of the candidate features having at least a threshold ranking.

4. The method of claim 1, wherein receiving the request from the client device for information relating to the non-fungible token comprises receiving information associated with a collection of non-fungible tokens of which the non-fungible token is a part.

5. The method of claim 4, wherein the supervised machine learning model is selected from a plurality of candidate supervised machine learning models based on the information associated with the collection of non-fungible tokens of which the non-fungible token is a part.

6. The method of claim 1, further comprising:
responsive to the request omitting an indication of a collection to which the non-fungible token belongs, determining the collection by:
querying a database with a query having information in the request; and
receiving the indication of the collection in response to the query; and
using the collection as a signal of the set of signals.

7. The method of claim 1, further comprising:
determining that the non-fungible token is not part of a collection;
applying the set of signals into an unsupervised machine learning model trained to output a cluster of nearest non-fungible tokens; and
training the supervised machine learning model using historical data of the nearest non-fungible tokens.
querying a database with a query having information in the request; and
receiving the indication of the collection in response to the query; and
using the collection as a signal of the set of signals.

8. A non-transitory computer-readable medium comprising memory with instructions encoded thereon that, when executed, cause one or more processors to perform operations, the instructions comprising instructions to:
receive a request from a client device for information relating to a non-fungible token;
determine, based on the request, a set of signals to extract relative to the non-fungible token;
input the set of signals into a supervised machine learning model;
receive, as output from the supervised machine learning mode, a prediction for the non-fungible token; and
output, for display on the client device, the information relating to the non-fungible token, the information determined based on the prediction.

9. The non-transitory computer-readable medium of claim 8, the instructions further comprising instructions to select the supervised machine learning model from a plurality of candidate supervised machine learning model, each candidate supervised machine learning model corresponding to a different set of signals.

10. The non-transitory computer-readable medium of claim 8, wherein the instructions to determine the set of signals comprise instructions to:
determine, for the supervised machine learning model, a contribution of each candidate feature to prediction results of the supervised machine learning model;
rank candidate features based on their contribution; and
determine the set of signals to correspond to ones of the candidate features having at least a threshold ranking.

11. The non-transitory computer-readable medium of claim 8, wherein the instructions to receive the request from the client device for information relating to the non-fungible token comprise instructions to receive information associated with a collection of non-fungible tokens of which the non-fungible token is a part.

12. The non-transitory computer-readable medium of claim 11, wherein the supervised machine learning model is selected from a plurality of candidate supervised machine learning models based on the information associated with the collection of non-fungible tokens of which the non-fungible token is a part.

13. The non-transitory computer-readable medium of claim 8, the instructions further comprising instructions to:
responsive to the request omitting an indication of a collection to which the non-fungible token belongs, determine the collection by:
querying a database with a query having information in the request; and
receiving the indication of the collection in response to the query; and
use the collection as a signal of the set of signals.

14. The non-transitory computer-readable medium of claim 8, the instructions further comprising instructions to:
determine that the non-fungible token is not part of a collection;
apply the set of signals into an unsupervised machine learning model trained to output a cluster of nearest non-fungible tokens; and
train the supervised machine learning model using historical data of the nearest non-fungible tokens.

15. A system comprising:
memory with instructions encoded thereon; and
one or more processors that, when executing the instructions, are caused to perform operations comprising:
receiving a request from a client device for information relating to a non-fungible token;
determining, based on the request, a set of signals to extract relative to the non-fungible token;
inputting the set of signals into a supervised machine learning model;
receiving, as output from the supervised machine learning mode, a prediction for the non-fungible token; and
outputting, for display on the client device, the information relating to the non-fungible token, the information determined based on the prediction.

16. The system of claim 15, the operations further comprising selecting the supervised machine learning model from a plurality of candidate supervised machine learning model, each candidate supervised machine learning model corresponding to a different set of signals.

17. The system of claim 15, wherein determining the set of signals comprises:
determining, for the supervised machine learning model, a contribution of each candidate feature to prediction results of the supervised machine learning model;
ranking candidate features based on their contribution; and
determining the set of signals to correspond to ones of the candidate features having at least a threshold ranking.

18. The system of claim 15, wherein receiving the request from the client device for information relating to the non-fungible token comprises receiving information associated with a collection of non-fungible tokens of which the non-fungible token is a part.

19. The system of claim 18, wherein the supervised machine learning model is selected from a plurality of candidate supervised machine learning models based on the information associated with the collection of non-fungible tokens of which the non-fungible token is a part.

20. The system of claim 15, the operations further comprising:
responsive to the request omitting an indication of a collection to which the non-fungible token belongs, determining the collection by:
querying a database with a query having information in the request; and
receiving the indication of the collection in response to the query; and
using the collection as a signal of the set of signals.
